(19) United States
(12) Patent Application Publication
(10) Pub. No.: US 2026/0316420 A1
(43) Pub. Date: Oct. 15, 2026

(54) ORTHOGONAL CARBON-NANOTUBE-BASED NANOFOREST FOR HIGH-PERFORMANCE HIERARCHICAL MULTIFUNCTIONAL NANOCOMPOSITES

(71) Applicants: Goodman Technologies LLC, Albuquerque, NM (US); University of Hawai'i, Honolulu, HI (US)

(72) Inventors: William A. Goodman, Albuquerque, NM (US); Mohammad Naghi Ghasemi-Nejhad, Honolulu, HI (US); Pouria Taeb, Kapolei, HI (US); Brenden Masao Minei, Honolulu, HI (US)

(73) Assignees: Goodman Technologies LLC, Albuquerque, NM (US); University of Hawai'i, Honolulu, HI (US)

(21) Appl. No.: 19/658,059

(22) Filed: Apr. 24, 2026

Related U.S. Application Data
(63) Continuation-in-part of application No. 17/795,969, filed on Jan. 28, 2021, now abandoned.
(60) Provisional application No. 62/966,958, filed on Jan. 28, 2020.

(51) Int. Cl. B32B 7/03; B32B 3/12; B32B 5/02; B32B 15/08

(52) U.S. Cl. CPC B32B 7/03; B32B 3/12; B32B 5/02; B32B 15/08; B32B 2255/02; B32B 2255/20; B32B 2262/103; B32B 2307/7375

(57) ABSTRACT

A reinforcement for increasing the strength and toughness and other properties in both transverse and in-plane directions for a composite material, and methods of manufacture therefor. The reinforcement has a layer of a nanoforest of vertical nanotubes or nanowires and a layer of horizontal nanotubes or nanowires. The reinforcement can be made by rolling a vertical nanoforest to produce a collapsed layer of horizontal nanotubes or nanowires, then growing a vertical nanoforest on the collapsed layer. The reinforcement can be grown directly on fibers which are used to reinforce the composite material, or alternatively interleaved with layers of those fibers before the composite part is cured. The reinforcement and manufacturing method are compatible with almost any composite material in any shape, including thermoset, thermoplastic, or ceramic matrix composites, or any manufacturing method, including prepreg, wet-layup and matrix film stacking. The present invention reduces scrap, rework, and repair hours for composites manufacturing.

### CROSS-REFERENCE TO RELATED APPLICATIONS

This application is a continuation-in-part application of U.S. patent application Ser. No. 17/795,969, filed on Jul. 28, 2022, entitled “ORTHOGONAL CARBON-NANOTUBE-BASED NANOFOREST FOR HIGH-PERFORMANCE HIERARCHICAL MULTIFUNCTIONAL NANOCOMPOSITES”, which is a 371 application of International Patent Application No. PCT/US2021/015588, filed on Jan. 28, 2021, entitled “ORTHOGONAL CARBON-NANOTUBE-BASED NANOFOREST FOR HIGH-PERFORMANCE HIERARCHICAL MULTIFUNCTIONAL NANOCOMPOSITES”, which application claims priority to and the benefit of the filing of U.S. Provisional Patent Application No. 62/966,958, filed on Jan. 28, 2020, entitled “Orthogonal Carbon-Nanotube-Based Nanoforest For High-Performance Hierarchical Multifunctional Nanocomposites”, filed on Jan. 28, 2020. The entirety of each of the aforesaid applications is incorporated herein by reference.

### STATEMENT REGARDING FEDERALLY SPONSORED RESEARCH OR DEVELOPMENT

This invention was made with government support under Contract No. N68335-20-C-0493 awarded by the Office of Naval Research. The government has certain rights in the invention.

### BACKGROUND OF THE INVENTION

### Field of the Invention (Technical Field)

The present invention is related to nano-reinforcements for multifunctional structural and non-structural nanocomposites.

### Background Art

Note that the following discussion may refer to a number of publications and references. Discussion of such publications herein is given for more complete background of the scientific principles and is not to be construed as an admission that such publications are prior art for patentability determination purposes.

The field of nanocomposites involves the study of multiphase materials where at least one of the constituent phases has one dimension less than 100 nm. This is the range where the phenomena associated with the atomic and molecular interaction strongly influence the macroscopic properties of materials. Since the building blocks of nanocomposites are at nanoscale, and nanomaterials have enormous surface areas, there are numerous interfaces between the intermixed phases. The special properties of the nanocomposite arise from the interaction of its phases at the interface and/or interphase regions. By contrast, in a conventional composite based on micrometer sized fillers such as carbon fiber, the interfaces between the filler and matrix constitutes have much smaller surface-to-volume ratios than the bulk materials, and hence they influence the properties of the host structure to a much smaller extent. The promise of nanocomposites lies in their multifunctionality, i.e., the possibility of realizing unique combination of various properties unachievable with traditional materials.

Motivated by the recent enthusiasm in nanotechnology, development of nanocomposites is one of the rapidly evolving areas of composites research.

Scientists and engineers working with fiber-reinforced composites have practiced this “bottom-up” approach in processing and manufacturing, at micron level, for decades. When designing a composite, the material properties are tailored for the desired performance across various length scales (e.g., from micro-size to macro-size). From the selection and processing of matrix and fiber materials and architecture, to the lay-up of laminae in laminated composites, and finally to the net-shape forming of the macroscopic composite parts, the integrated approach used in composites processing is a remarkable example in the successful use of the “bottom-up” approach (albeit at the micron level) even prior to the development of nanocomposites.

The composites of the future will offer many advances over composites of today. Recent developments in the production and characterization of various nanoparticles have created numerous new opportunities to develop nanocomposites for different applications. The potential to develop carbon nanotube (CNT) reinforced nanocomposites looks promising for a wide range of applications including high mechanical damping, strength, strain-to-failure, fracture toughness, and electrically and thermally conductive polymer nanocomposites, while reducing their coefficient of thermal expansion. However, applications using CNTs as structural reinforcements depend on their ability to transfer load from the matrix to the nanotubes.

Significant improvements in the in-plane mechanical properties of CNT reinforced composites compared to their unreinforced counterparts have been reported. In one example the compression modulus of multi-walled carbon nanotubes (MWCNT)/epoxy nanocomposites was higher than the tensile modulus, indicating that the load transfer to the nanotubes in the composite is much higher in compression. Nanomaterials have been employed within epoxy and polyester to improve strength, strain-to-failure, and fracture toughness of the developed nanocomposites. In view of their importance and utility in space, aerospace (both commercial and military), automotive, communication, sport goods, and renewable energy fields, carbon fiber reinforced polymers (CFRP) and glass fiber reinforced polymers (GFRP) are currently being extensively studied and used. This is because this class of materials possesses admirable properties, low weight, high fracture toughness, and relatively high strength.

As disclosed in U.S. Patent Publication Number 2013/0216811, incorporated herein by reference, carbon nanotube nanoforests have been grown on the surface of woven fabrics to develop high-performance composites with improved strength, stiffness, toughness, and damping properties as well as electrical and thermal conductivities, and lower CTE (Coefficient of Thermal Expansion) properties. A nanotape technology can be interleaved between the composite layers, either wet lay-up or prepreg.

The influence of the incorporation of nanoscale materials into adhesives for the purpose of joining two dissimilar materials has not been investigated thoroughly. This may be due to the large variance in function, intricacy of geometry, incompatibility of materials, and operating conditions. Structural bonded joints can fail at different locations and by a variety of failure modes. In case of joining composites using adhesives, failure can occur or initiate in the adhesive or in the adherent, depending on the geometrical configuration, the materials of the adherents, the adhesive as well as the manufacturing processes.

To use mechanical fasteners to join composites, normally cut-outs (such as a circular hole) are introduced into the structure. The presence of such holes increases stress concentrations by a factor of 3 for isotropic materials such as metals, alloys, ceramics, and polymers, and somewhat less than 3 for anisotropic materials such as composites.

### SUMMARY OF THE INVENTION (DISCLOSURE OF THE INVENTION)

An embodiment of the present invention is a nanoforest-based reinforcement comprising a first layer comprising substantially horizontally oriented elongated nanostructures, i.e. substantially parallel to the surface of a substrate, and a second layer comprising a nanoforest comprising elongated nanostructures that are substantially vertically oriented, i.e. substantially perpendicular to the surface of the substrate. The second layer was preferably grown directly on the first layer, preferably in the same furnace and after deposition of a catalyst, without any intermediate transfer step or adhesive, so that the second layer is in direct contact with the first layer (except for the catalyst) with no arcuate, tangled, or adhesive interface therebetween. A uniform and/or dense layer of catalyst preferably remains between the first layer and the second layer. The first layer preferably comprises a collapsed nanoforest, the nanoforest originally comprising elongated nanostructures which were oriented substantially perpendicular to the surface of the substrate. The second layer preferably has a height between about 10 microns and about 20 microns. The first layer preferably has a height between about 5 microns and about 10 microns. The nanoforest-based reinforcement preferably has a total height of less than about 50 microns. The elongated nanostructures may comprise any compound, element, ceramic, metal, or other material, including but not limited to carbon, gold, BN, Si, CuO, or ZnO. Any of the aforesaid elements or features may be combined with one or more of the other aforesaid elements or features, in any combination.

Another embodiment of the present invention is a composite part comprising a plurality of layers of the nanoforest-based reinforcement above interleaved with a plurality of fiber reinforcement layers. The nanoforest-based reinforcement is optionally grown directly on the fiber reinforcement layers. Each of the plurality of layers of the nanoforest-based reinforcement preferably fills between about 40% and about 80% of a distance between consecutive fiber reinforcement layers. Each of the plurality of layers of the nanoforest-based reinforcement preferably has a height of 20-40 micrometers to fill a gap of 50 micrometers between consecutive fiber reinforcement layers. The composite part preferably comprises a matrix comprising a cured material selected from the group consisting of epoxy, cured thermosetting polymer resin, cured thermoplastic polymer resin, cured polyimide resin, cured bismaleimide resin, and ceramized preceramic polymer. The fiber reinforcement layers optionally comprise carbon, glass, Kevlar, Spectra, silicon carbide, silicon nitride, alumina, or combinations thereof. Each fiber reinforcement layer optionally comprises a fabric, optionally a metal fabric, or a unidirectional prepreg and/or a fabric prepreg. The composite part optionally comprises a sandwich structure comprising face sheets and one or more core/honeycomb portions, wherein the nanoforest-based reinforcement is located at interfaces between the face sheets and the core/honeycomb portions. The composite part optionally comprises a flat, curved, contoured, or multi-curvature geometry. Any of the aforesaid elements or features may be combined with one or more of the other aforesaid elements or features, in any combination.

Another embodiment of the present invention is a method of making a nanoforest-based reinforcement, the method comprising growing a first nanoforest comprising elongated nanostructures on a substrate, the elongated nanostructures oriented substantially perpendicular to a surface of a substrate; rolling the nanoforest to form a collapsed layer comprising elongated nanostructures that are oriented substantially parallel to the surface of the substrate; and growing a second nanoforest comprising elongated nanostructures on the collapsed layer, the elongated nanostructures oriented substantially perpendicular to the surface of the substrate. The two growing steps are preferably performed in the same furnace. The method optionally comprises removing the first nanoforest from the substrate prior to the rolling step. The nanoforest is optionally placed between two polytetrafluoroethylene sheets prior to the rolling step. The nanoforest, with or without the polytetrafluoroethylene sheets, is optionally placed between two metal sheets prior to the rolling step. Each metal sheet optionally comprises aluminum, steel, copper, or zinc, and preferably has a thickness of about 1 mm. The method optionally comprises depositing a preferably substantially uniform catalyst layer on the substrate prior to the step of growing the first nanoforest and/or prior to the step of growing the second nanoforest. Any of the aforesaid steps, elements or features may be combined with one or more of the other aforesaid steps, elements or features, in any combination.

Another embodiment of the present invention is a method of manufacturing a composite part, the method comprising producing the nanoforest-based reinforcement made in accordance with the method above; interleaving a plurality of layers comprising the nanoforest-based reinforcement with a plurality of fiber reinforcement layers; and curing the composite part. The material of the substrate is optionally selected from the group consisting of silicon, silicon oxide, steel, stainless steel, silicon carbide, silicon oxide, boron carbide, boron nitride, silicon nitride, alumina, quartz, glass, quartz glass, and copper. After the interleaving step each of the plurality of layers comprising the nanoforest-based reinforcement preferably fills between about 40% and about 80% of a distance between consecutive fiber reinforcement layers. The substrate is preferably removed from the nanoforest-based reinforcement prior to the interleaving step. The fiber reinforcement layers optionally comprise prepreg layers. Alternatively, the method optionally comprising wetting the interleaved nanoforest-based reinforcement layers and fiber reinforcement layers with a liquid matrix material prior to the curing step. The liquid matrix material is preferably selected from the group consisting of epoxy, thermosetting polymer resin, thermoplastic polymer resin, polyimide resin, bismaleimide resin, and preceramic polymer. Or, the method optionally comprises stacking the interleaved nanoforest-based reinforcement layers and fiber reinforcement layers with a plurality of matrix film layers prior to the curing step. Any of the aforesaid steps, elements or features may be combined with one or more of the other aforesaid steps, elements or features, in any combination.

Another embodiment of the present invention is a method of manufacturing a composite part, the method comprising producing the nanoforest-based reinforcement made in accordance with the method above, wherein the substrate comprises a fiber reinforcement fabric; stacking a plurality of layers of the fiber reinforcement fabric; and curing the composite part. The method optionally comprises wetting the stacked layers with a liquid polymer matrix material prior to the curing step, or alternatively optionally comprises stacking the layers with a plurality of matrix film layers prior to the curing step. Any of the aforesaid steps, elements or features may be combined with one or more of the other aforesaid steps, elements or features, in any combination.

Another embodiment of the present invention is a method of manufacturing a composite part, the method comprising producing the nanoforest-based reinforcement made in accordance with the method above; and incorporating the nanoforest-based reinforcement into the composite part using a manufacturing method selected from the group consisting of wet lay-up, prepreg lay-up, automated or manual wet lay-up or prepreg or film-stack roll wrapping, tape laying for thermosetting or thermoplastic composites, room-temperature cure, autoclave cure, inside autoclave processing, out-of-autoclave processing, resin transfer molding (RTM), open or closed mold vacuum assisted resin transfer molding (VARTM), reaction injection molding (RIM), structural reaction injection molding (SRIM), elastic reservoir molding (ERM), sheet molding compound (SMC), compression molding, co-cured sandwich structure manufacture, pultrusion, diaphragm molding/forming, hydroforming, thermoforming, and matched die forming.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate the practice of embodiments of the present invention and, together with the description, serve to explain the principles of the invention. The drawings are only for the purpose of illustrating certain embodiments of the invention and are not to be construed as limiting the invention. In the drawings:

FIG. 1 is a schematic of a simple chemical vapor deposition system for the growth of carbon nanotubes.

FIG. 2 is a schematic of a chemical vapor deposition system for the growth of multi-walled carbon nanotubes.

FIG. 3 is a photograph of a chemical vapor deposition system for the growth of multi-walled carbon nanotubes.

FIG. 4 is a typical photo of vertically aligned high density arrays of multi-walled carbon nanotubes (MWCNTs) grown over silicon and silicon oxide wafer using chemical vapor deposition (CVD).

FIG. 5 is a scanning electron microscope (SEM) image of the vertically aligned high density arrays of MWCNTs grown over silicon and silicon oxide wafer using CVD.

FIG. 6 is a schematic showing an example using of a tough flexible metallic sheet for the rolling processes of FIGS. 8-9.

FIG. 7 shows a typical tough flexible metallic sheet for the rolling processes of FIGS. 8-9.

FIG. 8 is a schematic showing a single press-rolling technique to produce a horizontally aligned carbon nanotube nanoforest (HA-CNT-NF) from a vertically aligned carbon nanotube nanoforest (VA-CNT-NF).

FIG. 9 is a schematic showing a double press-rolling technique to produce HA-CNT-NF from VA-CNT-NF.

FIG. 10 is a schematic of typical orthogonal nanoforest technology of the present invention where a VA-CNT-NF is grown or placed on top of a HA-CNT-NF.

FIG. 11 is a schematic of a HA-CNT-NF embedded in a composite.

FIG. 12 shows the interlaminar distance between two plies of a composite without CNTs, where the inset shows a nanocomposite where the interlaminar distance is filled with a HA-CNT-NF.

FIG. 13 shows dimensions of a single carbon fiber compared to aligned horizontal carbon nanotubes within the HA-CNT-NF.

FIG. 14 shows a CVD furnace used in the manufacture of orthogonal nanoforests of the present invention.

FIG. 15 is an SEM micrograph showing a top view of an orthogonal NF of the present invention showing the VA-CNT-NF layer.

FIG. 16 is an SEM micrograph showing a top view of an edge of a sample orthogonal nanoforest (NF).

FIG. 17 is an SEM micrograph showing a side view of an edge of a sample orthogonal NF.

FIG. 18 shows successful transfer of the orthogonal NF from the substrate on to the prepreg fabric.

FIG. 19 is an SEM micrograph showing full coverage of the orthogonal NF on the surface of the prepreg after transfer from the substrate.

FIG. 20 shows a schematic and photograph of a prepreg panel being vacuum bagged for the autoclaving process.

FIG. 21 shows a pristine carbon/epoxy prepreg panel (right) and a carbon/epoxy prepreg panel comprising the orthogonal NF (left) after they were cured in an autoclave.

FIG. 22 shows test strips cut from the pristine panel on the right side of FIG. 21 before double cantilever beam (DCB) testing.

FIG. 23 shows test strips cut from the orthogonal NF panel on the left side of FIG. 21 before DCB testing.

FIG. 24 shows the fractured surfaces of the pristine test strips of FIG. 22 after DCB testing.

FIG. 25 shows the fractured surfaces of the orthogonal NF test strips of FIG. 23 after DCB testing.

FIG. 26 is a graph showing Load vs. Extension data for pristine samples obtained by the DCB test. The hinge of Sample 1 broke mid-experiment, so it was omitted from this graph.

FIG. 27 is a graph showing Load vs. Extension data for orthogonal NF samples obtained by the DCB test.

FIG. 28 shows successful transfer of an orthogonal NF onto a carbon/polyimide prepreg.

FIG. 29 shows an orthogonal NF carbon/polyimide prepreg panel after autoclave curing.

FIG. 30 shows typical pristine (top) and orthogonal NF (bottom) carbon/polyimide test samples before DCB testing.

FIG. 31 shows typical fractured surfaces of pristine (top) and orthogonal NF (bottom) carbon/polyimide test samples after DCB testing.

FIG. 32 is a graph showing Load vs. Extension data for pristine carbon/polyimide samples obtained by the DCB test.

FIG. 33 is a graph showing Load vs. Extension data for orthogonal NF carbon/polyimide samples obtained by the DCB test.

FIG. 34 is a schematic of a porous, sponge-like nanostructure formed by growing a VA-CNT-NF over another VA-CNT-NF.

FIG. 35 is a scanning electron microscope (SEM) micrograph showing the approximate thickness of the CNT-based Nano-Sponge of Example 3.

FIGS. 36A-36D are SEM micrographs of the side of the Nano-Sponge of Example 3 taken at successively higher magnifications.

FIG. 37 shows the flexibility of the Nano-Sponge.

FIG. 38A shows a Nano-Sponge before the start of a flame test.

FIG. 38B shows the beginning of the flame test by dropping acetone on the Nano-Sponge.

FIG. 38C shows the Nano-Sponge with the acetone set on fire.

FIG. 38D shows shriveling of the Nano-Sponge as the trapped acetone is burned away.

FIG. 38E shows the Nano-Sponge immediately after the flame test, when it can be handled without discomfort in terms of heat and temperature.

FIG. 38F shows the Nano-Sponge of FIG. 38E opened and held under a Ruler to demonstrate that the Nano-Sponge held its original shape after the flame test.

### DETAILED DESCRIPTION OF EMBODIMENTS OF THE INVENTION

Embodiments of the present invention are a new class of nano-reinforcements (“orthogonal carbon-nanotube-based nanoforests”) that can be used to develop multifunctional structural and non-structural nanocomposites. In some embodiments the “orthogonal” nanoforest (NF) of the present invention comprises carbon nanotubes (CNTs) in both in-plane and out-of-plane directions. Although throughout the description carbon nanotubes are often specified, nanotubes or nanowires comprising any material, including but not limited to carbon, ZnO, BN, Si, CuO, and ZnO, may be used in the present invention.

The present invention may be used with a resin for any kind of polymer, such as thermosetting, thermoplastic, or preceramic polymers, to produce nanocomposites with performances higher than those of the resin. The present invention may also be used in a composite system by interleaving it within regular continuous fiber composites, for any type of fiber materials, such as carbon, glass, Kevlar, Spectra, silicon carbide, alumina, etc. or a hybrid/combination of them, and for any kind of fiber architecture, such as unidirectional, 2D woven, 3D triaxial/braided, etc. or any combinations thereof, for either a wet lay-up or a prepreg-based polymer to produce high-performance hierarchical (since the present invention is a bottom-up approach from nanoforest to microfibers to macro composites), multifunctional (since many different properties are improved) nanocomposites. The present invention may also be used within adhesives for joining two adherents to locally reinforce to strengthen and toughen the regions of joining and stress concentrations. Another application of the present invention is at and/or around the joint areas and cut-outs (such as holes) and where mechanical fasteners are needed for composites to locally reinforce to strengthen and toughen the regions of joining and stress concentrations. The structure around the holes area is locally reinforced by inserting the orthogonal nanoforest (preferably during the composites manufacturing) in between the layers locally in the areas where holes will be cut out (after the manufacturing of the composites panels), which effectively decreases the stress concentration factor and as a result increases the strength, strain-to-failure, and toughness of the materials locally around the hole and mechanical fasteners (where it is needed), thus substantially increasing the performance of the structure globally.

The present invention is applicable to a great majority of polymer composite manufacturing techniques, such as room temperature cure, autoclave (in-autoclave and out-of-autoclave) cure, compression molding, resin transfer molding (RTM), open or closed mold vacuum assisted resin transfer molding (VARTM), reaction injection molding (RIM), structural reaction injection molding (SRIM), elastic reservoir molding (ERM), sheet molding compound (SMC), manual or automated and wet lay-up or prepreg role wrapping, co-cured sandwiched structures, pultrusion, manual or automated and wet lay-up or prepreg or film-stack tape laying, in-situ (on-line consolidation) thermoplastic composites tape laying, filament winding by in-situ (on-line consolidation) thermoplastic composites tape laying, diaphragm forming, matched die forming, hydroforming, thermoforming, etc.

The present invention is useful with any geometry, such as flat, curved, contoured, and multi-curvature, and can be applied locally (i.e., around certain regions where the properties need to be improved locally) or globally (i.e., for the entire structure, where the properties need to be improved globally and everywhere in the structure). The structures comprising an orthogonal nanoforest of the present invention have improved properties such as physical, chemical, mechanical (both static strength, stiffness/modulus, strain, toughness, etc., and dynamic-- fatigue, impact, vibration, damping, etc.), electrical conductivity, thermal conductivity, thermoelastic, thermomechanical, electromagnetic interference, electromagnetic pulse, fire retardation, and reduction of coefficient of thermal expansion (CTE), coefficient of moisture absorption, etc. These improvements are preferably orthotropic using the orthogonal nanoforest. Also, the interleaving of the orthogonal nanoforest within the layered structures can be sequential and in-between all the layers, or alternating with a certain period of layers, or placed within only some of the layers. In addition, depending on the application, some of the orthogonal nanoforest can be replaced by some thin layer of metals (e.g., aluminum foils) or polymers (thermoplastic films) if certain materials properties are required.

In one or more embodiments of the present invention, orthogonal multi-walled carbon nanotubes (MWCNT) with diameters of less than 100 nm form an orthogonal nanoforest for use as reinforcements to enhance the overall performance of resins, adhesives, and composites, globally (when it is grown directly onto the fibers or when it is interleaved within the composites to cover the entire surface of the parts) or locally (when it is used to locally reinforce the locations of joints, cut-outs, holes, etc., where stress concentrations exist). One embodiment of a manufacturing method for the orthogonal nanoforest is as follows. A suitable substrate (either a fiber for the direct growth of the CNTs or a substrate to create a CNT nanoforest) is prepared with an optional thin catalyst layer (such as iron, nickel, or cobalt) preferably having a thickness suitable for the growth of carbon nanotubes, preferably about 10-20 microns. Any substrate suitable for nanotube or nanowire growth may be used, including but not limited to silicon, silicon oxide, steel, stainless steel, ceramics (such as silicon carbide, silicon oxide, boron carbide, boron nitride, silicon nitride, or alumina), quartz, glass, or copper. The nanotubes or nanowires may be grown directly on fibers or fabrics, including but not limited to carbon, glass, Kevlar, Spectra, or ceramic fibers. As used throughout the specification and claims, the term “substrate” includes substrate, surface, fiber, fabric, and the like. As used throughout the specification and claims, the term “elongated nanostructure” means nanotube, nanowire, nanorod, and the like. As used throughout the specification and claims, the term “nanoforest” means a plurality of elongated nanostructures grown on the same substrate whose long axes are substantially parallel and aligned in the same direction.

The fiber or substrate is placed inside a CVD furnace and a proper mixture of a carbon-source fluid (such as xylene) and a proper catalyst material, such as ferrocene (if the substrate does not already have the catalyst layer), preferably with a ratio of 2 g of ferrocene in 100 g of xylene, is fed into the CVD furnace preferably at about 750 °C under suitable flow conditions to grow a Vertically Aligned Carbon Nanotube Nanoforest (VA-CNT-NF), preferably having a height of about 10-20 microns, on the substrate. The material is then cooled off preferably to about room temperature, preferably under an inert gas, for example argon, and removed from the CVD furnace. As described in more detail below, one or more Teflon film or films (or the like), preferably having a thickness of about 25 microns, are placed on the nanoforest and then rolled under pressure to collapse and align the CNTs substantially horizontally to form a Horizontally Aligned Carbon Nanotube Nanoforest (HA-CNT-NF), preferably having a height of about 5-10 microns after the collapse. The Teflon film(s) are removed and the HA-CNT-NF (on the fiber or substrate) is placed inside the CVD furnace, and the process of CNT growth for a VA-CNT-NF is repeated to grow a VA-CNT-NF, preferably having a height of about 10-20 microns, on the HA-CNT-NF, thus resulting in an orthogonal nanoforest which comprises CNTs in both the horizontal direction (i.e., in-plane direction) and vertical direction (i.e., out-of-plane direction), preferably comprising a total height of about 20-30 microns, suitable for being interleaved in between composite layers. The heights of the HA-CNT-CNT, VA-CNT-NF, and orthogonal NF are not limited to the heights mentioned here, and can be any desired height, shorter or taller. The VA-CNT-NF growth preferably is performed after a preferably uniform, dense layer of catalyst is deposited on the HA-CNT-NF, enabling the VA-CNT-NF to be well-aligned. The catalyst generally remains as an intervening layer between the VA-CNT-NF and the substrate or the underlying HA-CNT-NF (or underlying VA-CNT-NF for Nano-Sponges, as described in Example 3 below).

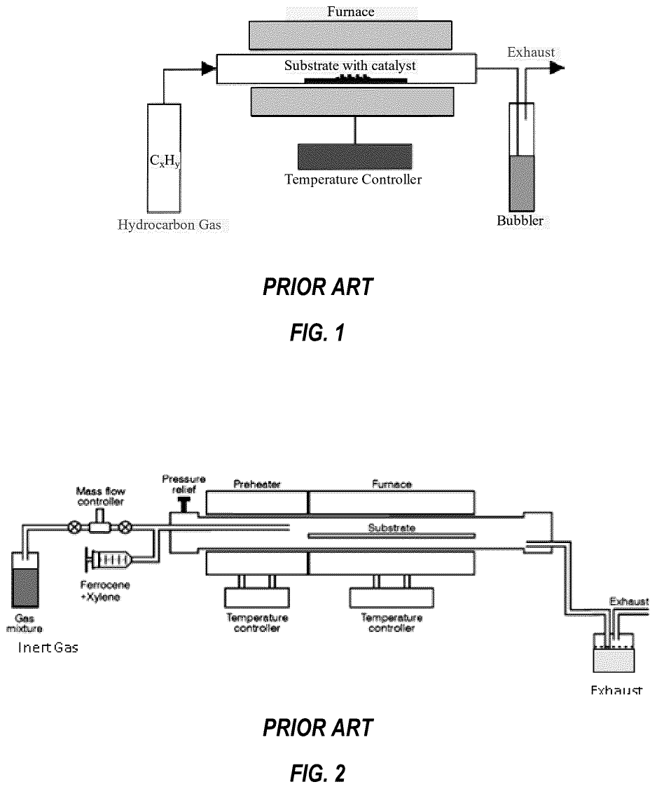

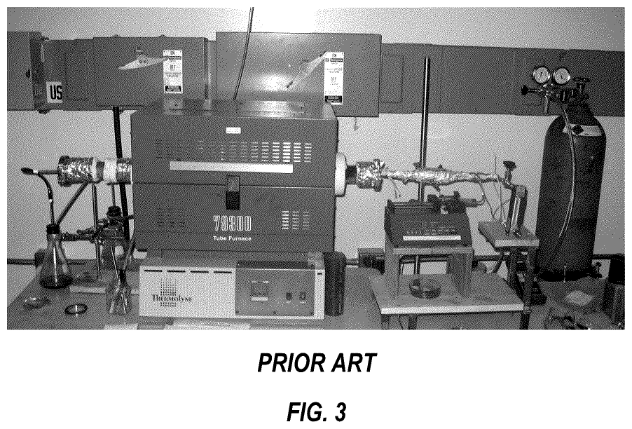

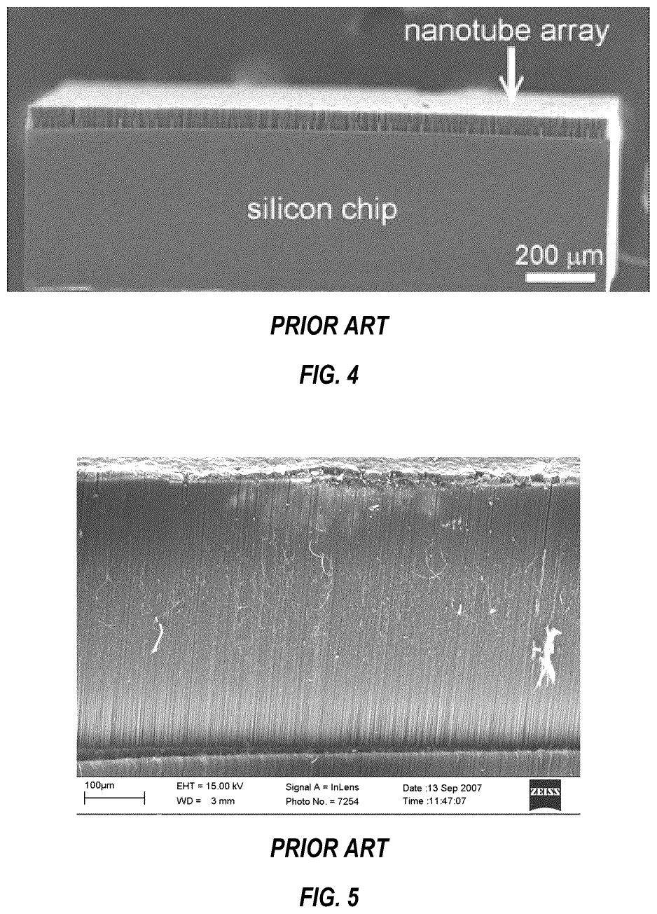

There are a number of techniques for the growth of VA-CNT-NFs, such as CVD, arc-discharge, and laser ablation. Within the CVD process, a substrate is preferably used. The substrate may optionally comprise a fiber or fibers. To grow VA-CNT-NFs via CVD, a catalyst layer is needed on the substrate so that the carbon atoms can form carbon nanotubes. There are two possibilities to deposit the catalyst layer on the substrate. In the first, as shown in FIG. 1, direct sputtering of iron, nickel, or cobalt on the substrate, preferably comprising a thin coating of a few microns, is performed. The catalyst coated substrate is then placed in the CVD furnace, and a carbon source is supplied into the CVD to grow the carbon nanotubes. In the second, as shown in FIGS. 2-3, a substrate is placed in the CVD furnace, and then a supply of a mixture of a carbon-source (for example, xylene, 100 g) and a catalyst material (for example, ferrocene, 2 g) is fed into the CVD furnace to grow the carbon nanotubes using proper temperature and flow conditions. In this method, the catalyst particles, being heavier than carbon atoms within the xylene and ferrocene mix, precipitate first on the substrate, and then carbon atoms deposit on top of the catalyst particles to form carbon nanotubes. In both cases, after the VA-CNT-NFs are grown to the desired length, the furnace is turned off and an inert gas (for example, argon) is flowed through the furnace till the furnace is cooled down to about room temperature, before the VA-CNT-NFs on the fiber or substrate can be removed from the furnace. CVD enables the CNTs to grow perpendicular to the surface of the fibers or substrates, as shown in FIGS. 4-5. The growth of carbon nanotubes on the surface of fibers is restricted by the surface chemical composition, the area over which the carbon nanotubes can grow in CVD, and the fiber resistance to high temperature processing in CVD. If needed, a thin coating of material, such as a polymer with a glass or ceramic backbone which is subsequently heated to a conversion temperature, can be applied on the fibers, upon which CNTs can grow easily. The above-mentioned techniques have been used successfully in applications where the CNT reinforcement of composites is primarily required in the through-the-thickness direction as well as improving the interlaminar properties of composites.

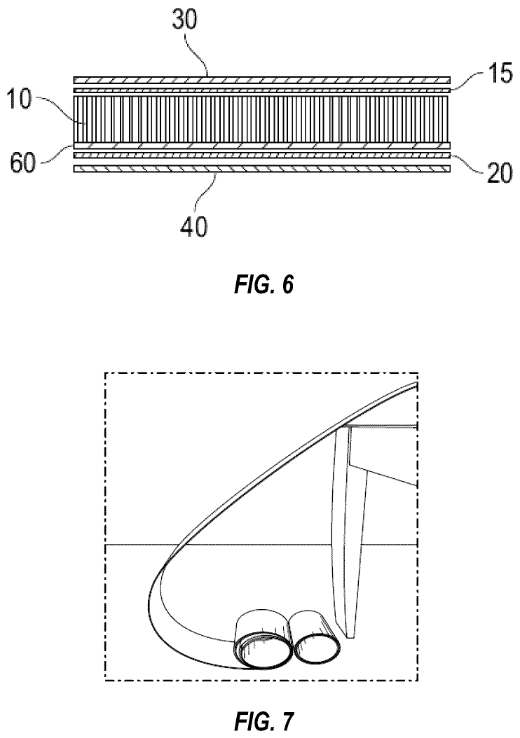

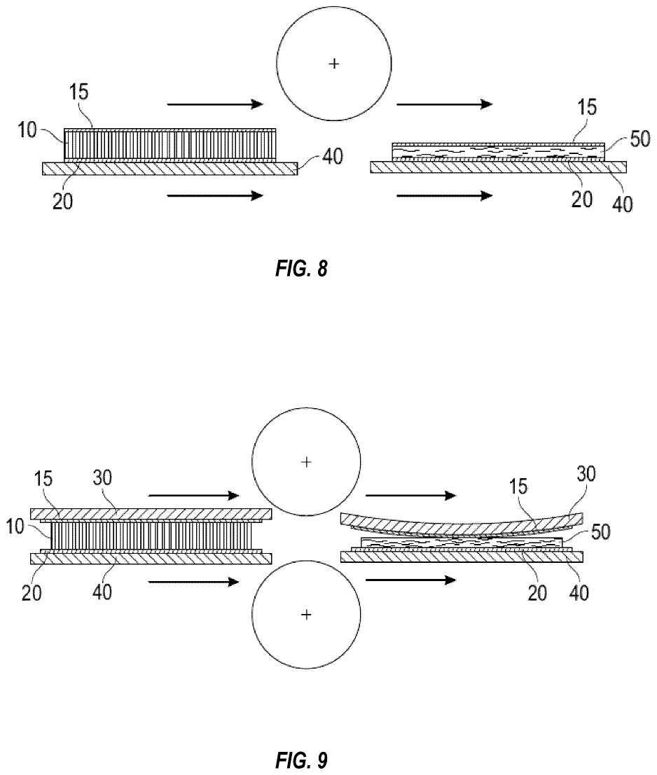

The process of collapsing the VA-CNT-NF into a HA-CNT-NF without fully or partially crushing the VA-CNT-NF (or the CNTs within) can be performed using a roller or a rolling machine. VA-CNT-NF 10 is optionally removed from substrate, fiber, or fabric 60, and placed between top Teflon film 15 and bottom Teflon film 20. The sandwich is then optionally placed between top metal sheet 30 and bottom metal sheet 40, as shown in the schematic of FIG. 6, which is not to scale. An example of the flexible metal sheet, which is preferably tough, flexible, and compliant, comprising aluminum about 1 mm thick, is shown in FIG. 7. FIGS. 8 and 9 are schematics showing the mechanism of collapsing VA-CNT-NF 10 to HA-CNT-NF 50 with single-sided rolling and double-sided rolling, respectively. In FIG. 8 the top metal sheet is not used, although it can be used in other embodiments. Similarly, the substrate is not shown in FIGS. 8 and 9; in other embodiments the VA-CNT-NF can be rolled while it is still on the substrate or fibers. Finally, the nanoforest can be placed directly between the metal sheets without using the Teflon.

One can visually determine if the vertical NF has been flattened by the roller to a horizontal orientation by observing the change in color of the NF layer. Since the vertically oriented CNTs absorb almost all the incident light directed at them, they appear as a darker shade of black compared to horizontal CNTs, which appear as grey.

In an alternative method, a HA-CNT-NF is created first (as explained above), and then instead of growing a VA-CNT-NF onto it directly (either on a fiber/fabric or on a substrate), a VA-CNT-NF is grown on a separate substrate and then removed and placed onto the HA-CNT-NF (either on a fiber or fabric or on the substrate).

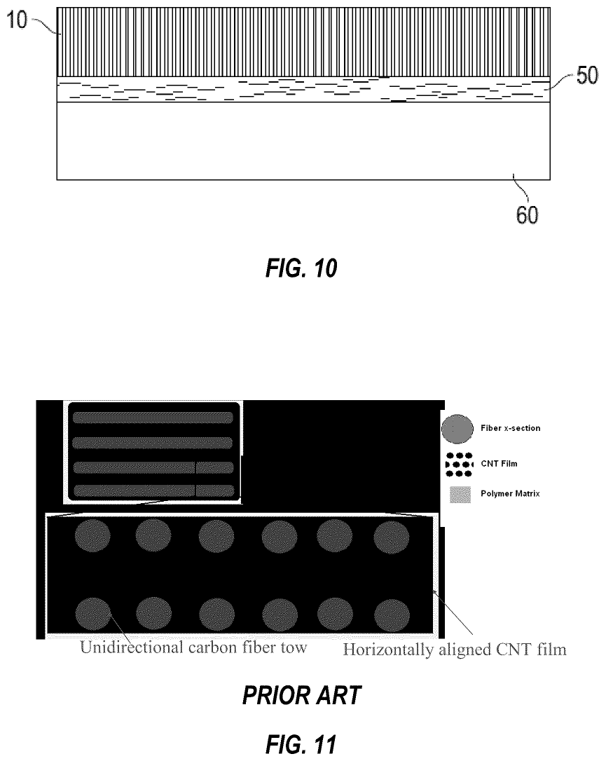

FIG. 10 shows a schematic of an embodiment of the orthogonal nanoforest of the present invention, comprising a VA-CNT-NF grown on top of a HA-CNT-NF. Alternatively, instead of having HA-CNT-NF at the bottom and VA-CNT-NF on top, one can create the opposite configuration of “orthogonality,” i.e., the VA-CNT-NF at the bottom and HA-CNT-NF on top. The alignment of the HA-CNT-NF and the VA-CNT-NF carbon nanotubes within the orthogonal nanoforest may deviate from fully horizontally aligned and/or fully vertically aligned; i.e., they may be at some angles other than perpendicular to each other, which may be desirable for some specific applications. The nanoforest shown in FIG. 10 as [HA-CNT-NF, VA-CNT-NF] n, has n=1; however, this n can be 1, 2, 3, and so on. Or it can be as [VA-CNT-NF, HA-CNT-NF] n, with n=1; however, this n can be 1, 2, 3, and so on, as explained above.

Important properties of good NF growth are the height, orientation, and density of the NF on the fibers or substrates. The total height of the orthogonal nanoforest preferably has a height of 20-40 micrometers to fill the gap between each ply of the composite laminate after curing. NF systems that are higher than about 50 micrometers can result in thicker than expected laminates. Since there is a limited amount of resin on the prepreg and preferably no additional resin is added to the nanoforest during layup, a NF much thicker than 50 micrometers can cause resin starvation in a laminate derived from a prepreg system, resulting in degradation of material properties for the resulting nanocomposites.

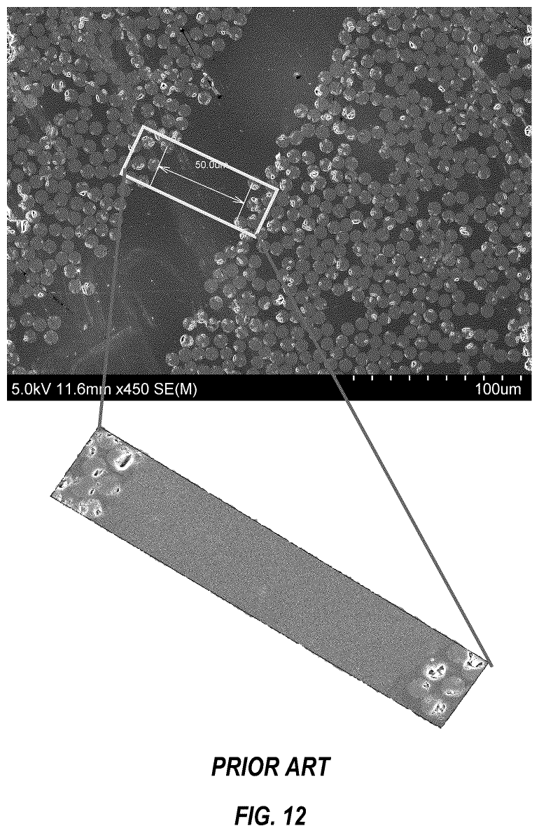

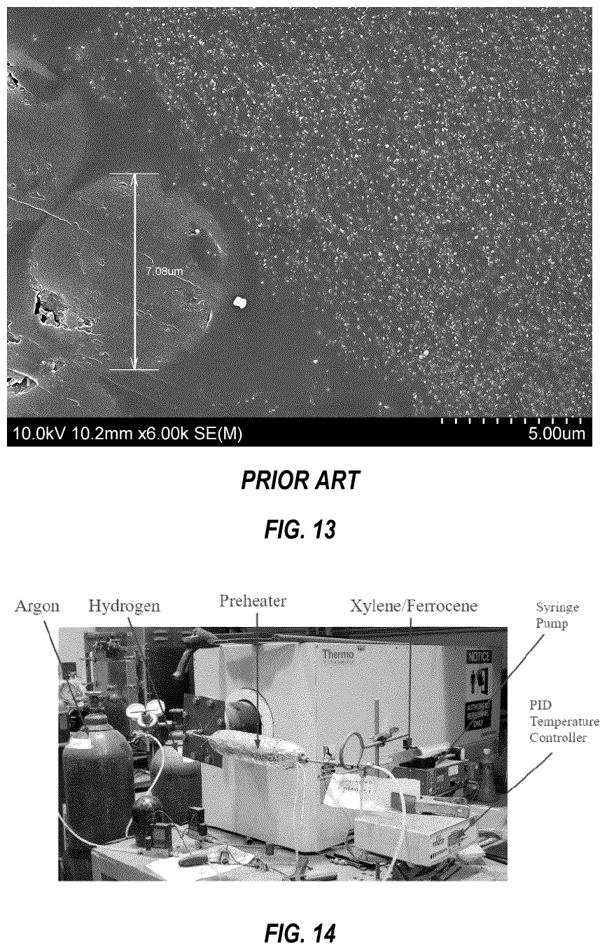

FIGS. 11-13 show a typical HA-CNT-NF filling the gap of about 50 microns between layers of carbon fibers in a composite. The orthogonal NF of the present invention, removed from its substrate, can be used similarly. The orthogonal NF can be transferred to and interleaved with layers of composite fibers or fabric for subsequent wet lay-up, transferred to lay atop another layer of film (film stacking), and/or incorporated with prepreg, to make a nanocomposite of the present invention.

Alternatively, the orthogonal nanoforest can be manufactured directly on the fibers or cloth, which is then wetted with a liquid polymer matrix or a matrix film, layered or stacked, and cured in a vacuum bag in an autoclave or hot press/compression molded to form the composite.

### Example 1: Carbon/Epoxy Prepreg System

A stainless-steel substrate was placed inside the quartz tube of a CVD (Chemical Vapor Deposition) furnace. Sanding and cleaning the substrate with alcohol prior to placement inside the furnace enabled more uniform NF growth. The CVD end caps were tightened by bolts and the syringe was filled with a precursor of xylene and ferrocene in the ratio of 100 g to 2 g and placed on the syringe pump. The quartz tube was then purged with argon. To enable more uniform growth of NF, the argon gas was passed through a flask filled with water prior to entering the furnace and the preheater. Once the tube was purged, the preheater and the furnace were turned on and set to heat up to about 200 °C and about 750 °C, respectively. After the furnace and the preheater reached the desired temperature, the syringe pumps and the hydrogen gas were turned on to start the growth cycle. The precursor was pumped through the lines into the preheater where they evaporated upon entering the furnace. Once the syringe was emptied, the syringe pump, the furnace, the preheater, and the hydrogen gas flow were turned off since the growth process had stopped and/or completed. The argon valve was turned so the argon was no longer passing through the water. After the furnace cooled down to under 200 °C the argon was turned off and the substrate was removed and allowed to cool down to room temperature.

The NF layer of vertically oriented CNTs was rolled using a rolling machine until the CNTs were in a flat (i.e. horizontal) orientation. The substrate was then placed back in the furnace for a second round of NF growth to grow vertically oriented CNTs on top of the horizontal CNTs from the first cycle in order to create an orthogonal NF. After the second cycle of CNT growth was completed (and the pumping/injection of xylene/ferrocene mixture flow was stopped), the chemical separation of the orthogonal NF from the substrate was performed as follows. The furnace, preheater, and the hydrogen gas remained on and the argon continued to flow through the water into the furnace. After about 30 min, the furnace, preheater, and hydrogen were turned off and the argon valve was switched so the gas no longer passed through the flask of water. At this time the furnace started cooling down under argon flow. Once the furnace reached about 200 °C, the argon was turned off and the substrate (with the orthogonal NF on it) was removed and allowed to cool down to room temperature.

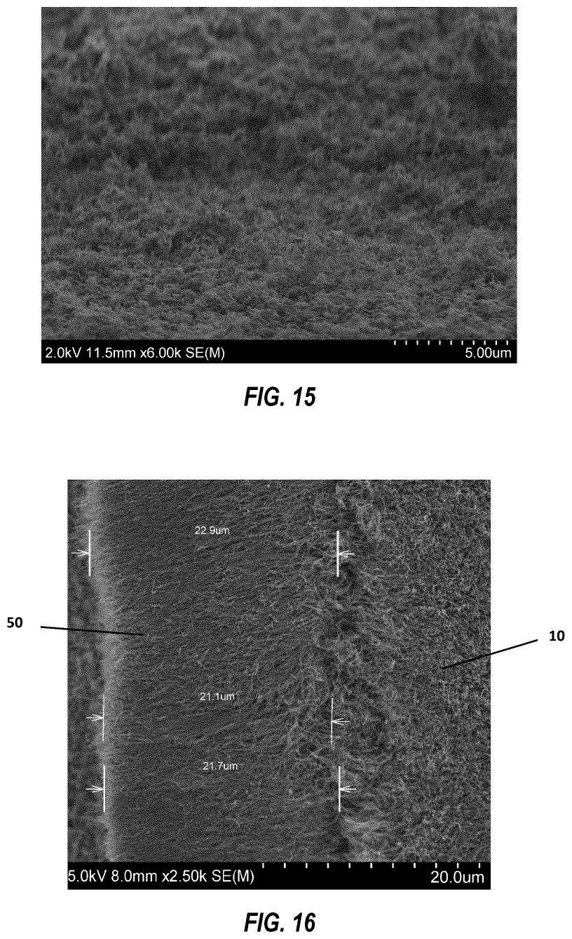

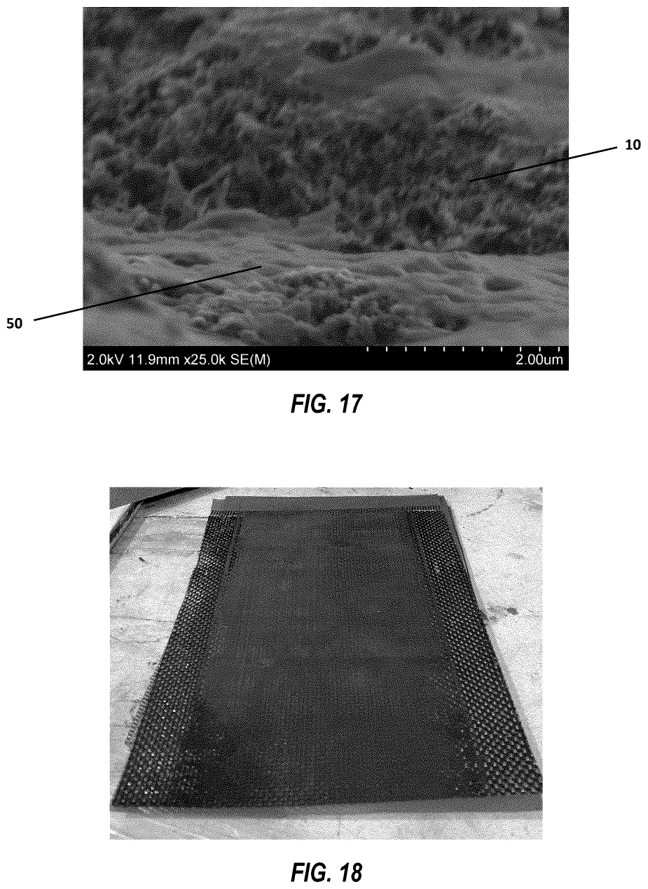

FIG. 14 shows the CVD furnace used in this example. FIGS. 15 and 16 are SEM top views of the orthogonal NF showing the VA-CNT-NF as the top layer. FIG. 17 is an SEM side view of the orthogonal NF. FIGS. 16 and 17 are taken at the edge of the sample showing the underlying horizontally aligned CNTs at the edge overlaid with the vertically aligned CNTs.

The orthogonal NF was then removed from the substrate and transferred onto a carbon/epoxy prepreg ply. This removal and transfer should be achieved with minimal damage to orientation and coverage. The prepreg was placed on top of the orthogonal NF and then some mild heat and pressure was applied to the assembly. At this stage, the substrate, the orthogonal NF, and the prepreg adhered together due to the adhesion of the epoxy on the prepreg. A razor was used to mechanically scrape the orthogonal NF off the substrate, preferably against the direction that the orthogonal NF was rolled to flatten the first layer. (In other examples, the orthogonal NF was first removed from the substrate using mechanical razor blades and then placed on the prepreg with some mild heat and pressure.) A photograph of a successful orthogonal NF transfer onto the prepreg is shown in FIG. 18.

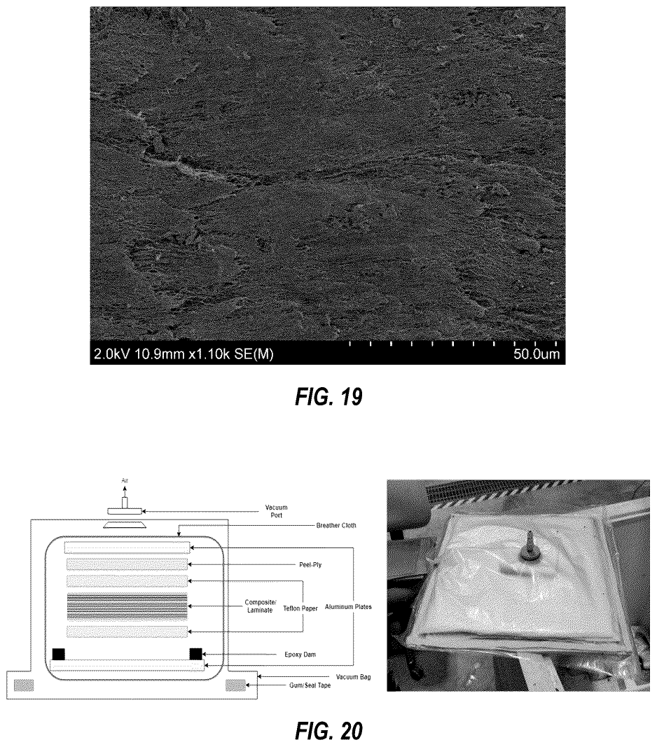

Complete coverage of the orthogonal NF on the prepreg reduces or eliminates the possibility of having voids or thickness variation in the final laminate. The SEM micrograph of FIG. 19 shows a top view of the orthogonal NF coverage on the prepreg after transfer from the substrate, showing the HA-CNT-NF shown on top of the VA-CNT-NF, which are touching the entire surface of the prepreg. The orthogonal NF layer order is thus inverted from its order on the substrate due to the transfer process.

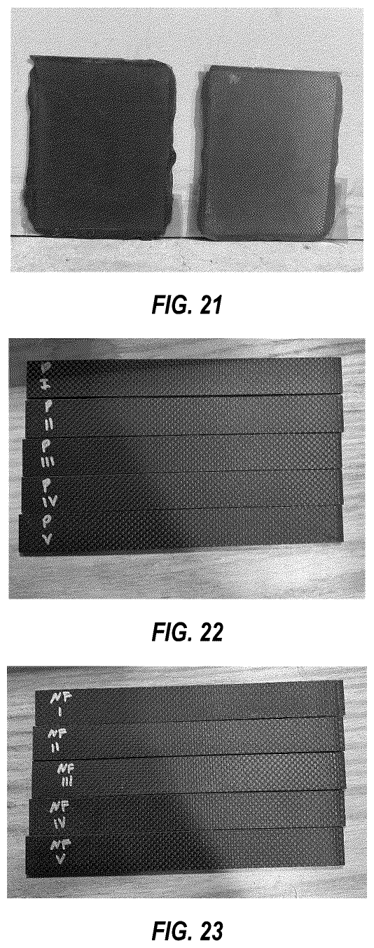

To determine the effect of the orthogonal NF on material property of composites, two panels were manufactured. The first panel (i.e., pristine panel) was used as the baseline material and comprised 16 plies of the prepreg plain weave carbon fabric/epoxy without the addition of orthogonal NF layers. The second panel comprised 16 layers of prepreg plain weave carbon fabric/epoxy with the addition of orthogonal NF layers in between each of the prepreg layers. Both panels were vacuum bagged as shown in FIG. 20 and cured in an autoclave using the manufacturer's recommended cure cycle. FIG. 21 shows the pristine (on the right) and the panel comprising the orthogonal NF (on the left) after they were cured in an autoclave.

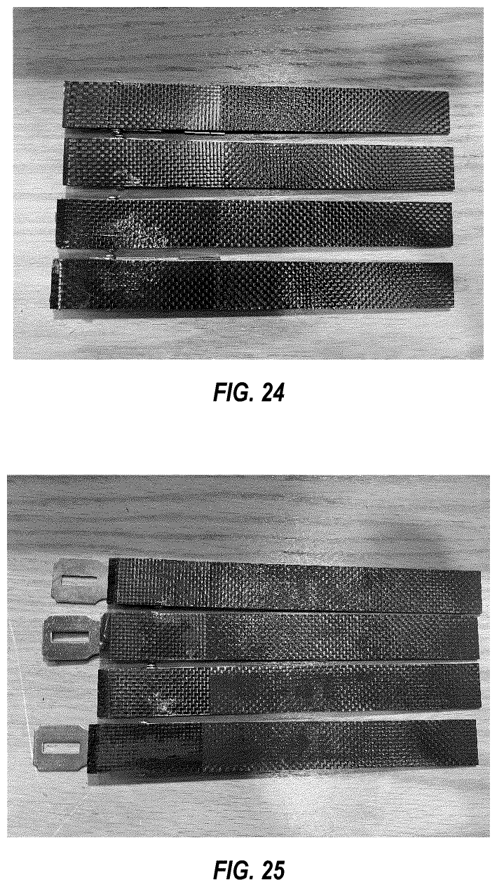

Each panel was cut into five test strips using a water jet to dimensions of about 160 mm×25 mm×4 mm according to the ASTM D 5528-01 standards (2019). Specimens were tested using an Instron testing machine to determine the effect of the orthogonal NF on mode I interlaminar fracture toughness, G_{ic}, determined using ASTM test method standard D 5528-01 (2019), Double Cantilever Beam (DCB) test. According to the ASTM Manual, the specimen should have a length of at least 125 mm, width of 20-25 mm, and thickness of 3 to 5 mm. Since each woven ply is 0.010″ thick, using 16 layers will produce a laminate with thickness of about 0.16″ (about 4 mm). FIGS. 22 and 23 show the pristine (designated by “P”) and orthogonal NF (designated by “NF”) test strips, respectively, before testing, and FIGS. 24 and 25 show the pristine and orthogonal NF test strips, respectively, after the DCB testing.

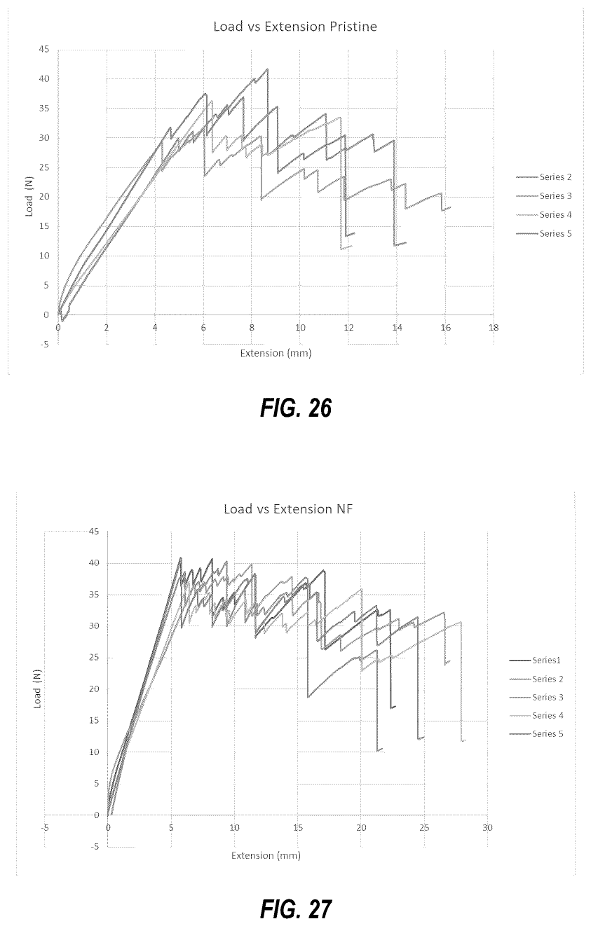

FIGS. 26 and 27 show the Load vs. Extension (i.e., the Instron jaws displacements) data for the pristine and orthogonal NF test strips, respectively. The orthogonal NF samples, which had a measured average fracture toughness of 342.62 J/m², showed a 62.3% improvement in interlaminar fracture toughness, G_{ic}, and were able to withstand higher max loads as well as higher extension values while maintaining higher loads, than the pristine samples, which had a measured average fracture toughness of 211.08 J/m².

### Example 2: Carbon/Polyimide Prepreg System

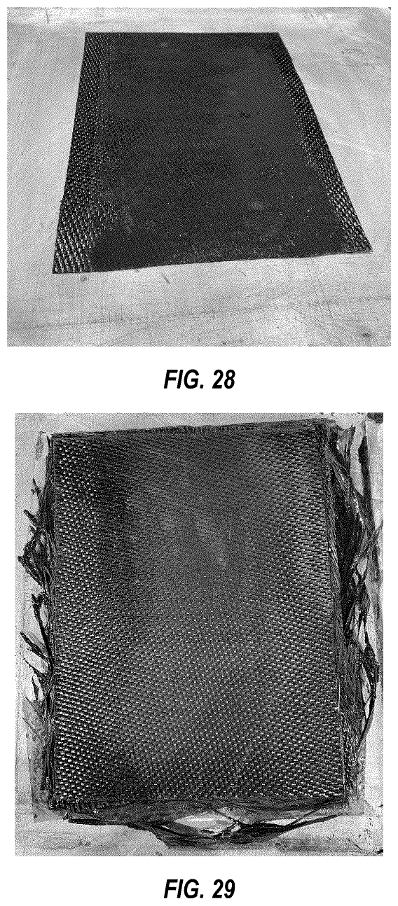

An orthogonal NF was prepared on a substrate in the same manner as described in Example 1. For the carbon/RM-1100 high temperature polyimide prepreg system of this experiment, the transfer process was able to be performed without the use of additional heat and with only minimal pressure, since the resin in the polyimide prepregs is tacky at room temperature. As in Example 1, a razor was used to mechanically scrape the orthogonal NF from the substrate. The successful transfer of the orthogonal NF to the prepreg is shown in FIG. 28. To determine the effect of orthogonal NF on material properties of composites in this example, two sets of panels were manufactured. The first “pristine” panel was used as the baseline material and comprised 8 plies of 8-harness woven (i.e. carbon fiber reinforced polyimide) carbon/polyimide prepreg fabric without the addition of the orthogonal NF. The second panel comprised 8 layers of 8-harness woven carbon/polyimide prepreg fabric with orthogonal NF in between each of the layers. The as-received 8-harness woven carbon/polyimide prepreg layers were thicker than the plain weave carbon/epoxy prepreg layers of Example 1. Both panels were then vacuum bagged and cured in an autoclave using the manufacturer's recommended cure cycle. FIG. 29 shows a carbon/polyimide panel with the orthogonal NF after it was cured in the autoclave.

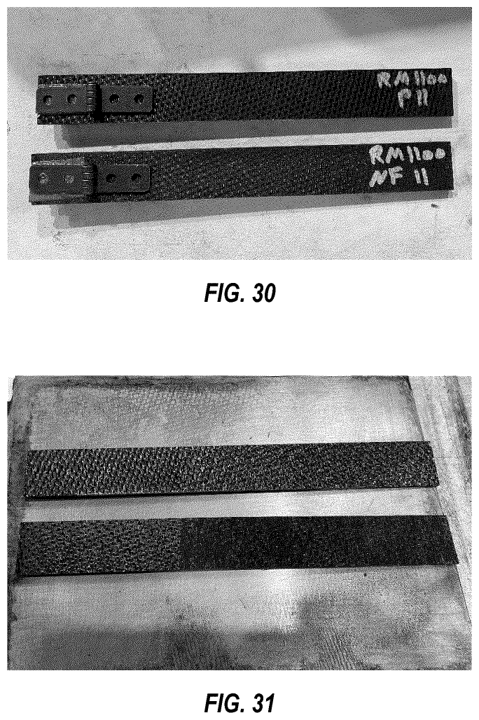

Specimens were tested using an Instron testing machine to determine the effect of orthogonal NF on Mode I interlaminar fracture toughness, G_{ic}, based on ASTM test method standard D 5528-01, Double Cantilever Beam (DCB) test (2019). According to the ASTM Manual, the specimen should have a length of at least 125 mm, width of 20-25 mm, and thickness of 3 to 5 mm for the DCB testing. For the 8-harness woven Carbon/Polyimide prepreg system used here, 8 layers of the prepreg produces a laminate with thickness of about 3 mm. Therefore, the panels were water jet cut to dimensions of about 160 mm×25 mm×3 mm. FIG. 30 shows typical pristine (top, designated by “P”) and orthogonal NF (bottom, designated by “NF”) specimens for the carbon/polyimide prepreg system used in this example. FIG. 31 shows typical fractured surfaces of the specimens for the pristine (top) and orthogonal NF (bottom) samples after the DCB tests.

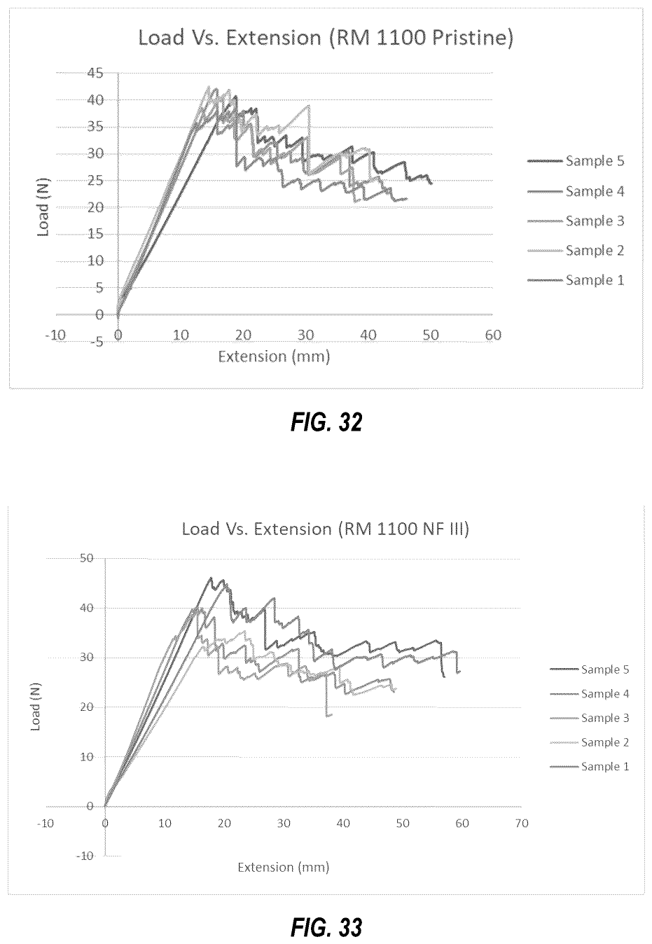

FIGS. 32 and 33 show the Load vs. Extension (Instron jaws Displacements) values for the pristine and orthogonal NF specimens, respectively. The orthogonal NF samples, which had a measured average fracture toughness of 900.07 J/m², showed a 27.1% improvement in interlaminar fracture toughness, G_{ic}, and were able to withstand higher max loads as well as higher extension values while maintaining higher loads, than the pristine samples, which had a measured average fracture toughness of 707.96 J/m².

### Example 3: Vertical Nanoforest Grown on Another Vertical Nanoforest

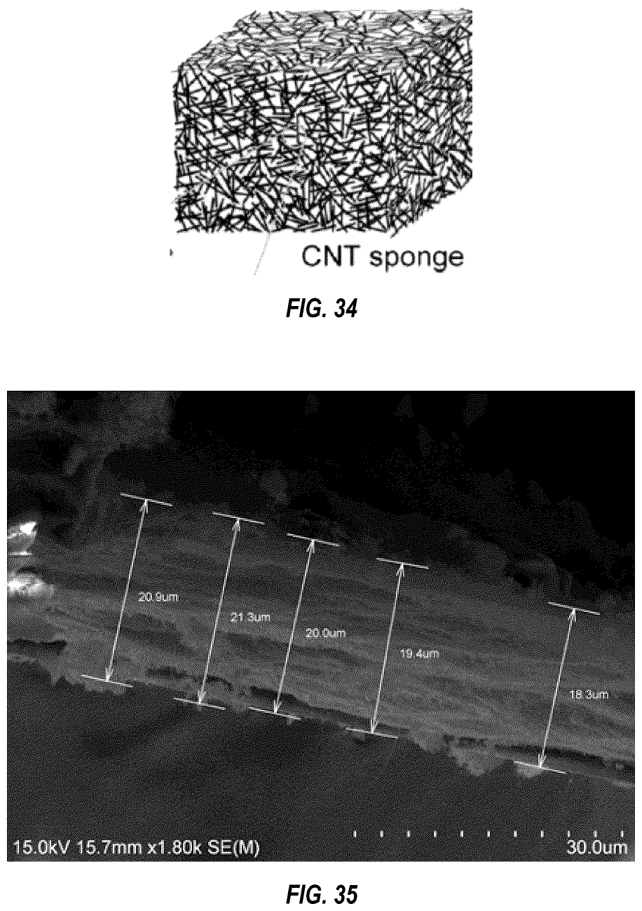

When growing a VA-CNT-NF on a HA-CNT-NF layer, the HA-CNT-NF is a smooth layer with little or no porosity, since the collapsed elongated nanostructures substantially cover each other; see FIG. 19. Thus, the catalyst layer deposited on the HA-CNT-NF prior to growth of the VA-CNT-NF is uniform and dense, which in turn results in a uniform, well-aligned VA-CNT-NF. In contrast, when growing a VA-CNT-NF over another VA-CNT-NF (typically in a CVD furnace), the catalyst for growing the top VA-CNT-NF is deposited over the tips of first VA-CNT-NF, and some will penetrate inside the first VA-CNT-NF structure due to the porosity of a VA-CNT-NF caused by the spaces between the elongated nanostructures when looking down from the top. This can easily be seen by rotating the micrograph in FIG. 5. The penetration of the catalyst into the bottom VA-CNT-NF distorts the alignments of both VA-CNT-NFs, creating a porous and sponge-like structure, or Nano-Sponge. FIG. 34 is a schematic of a Nano-Sponge; the CNTs (or other elongated nanostructures) are not aligned and are randomly oriented. Potential applications of Nano-Sponges include but are not limited to batteries, supercapacitors, fuel cell electrodes, composites (by infiltrating the Nano-Sponge), water filtration, desalination, oil Absorption, EMI shielding, conductive fabrics, and lightning strike protection.

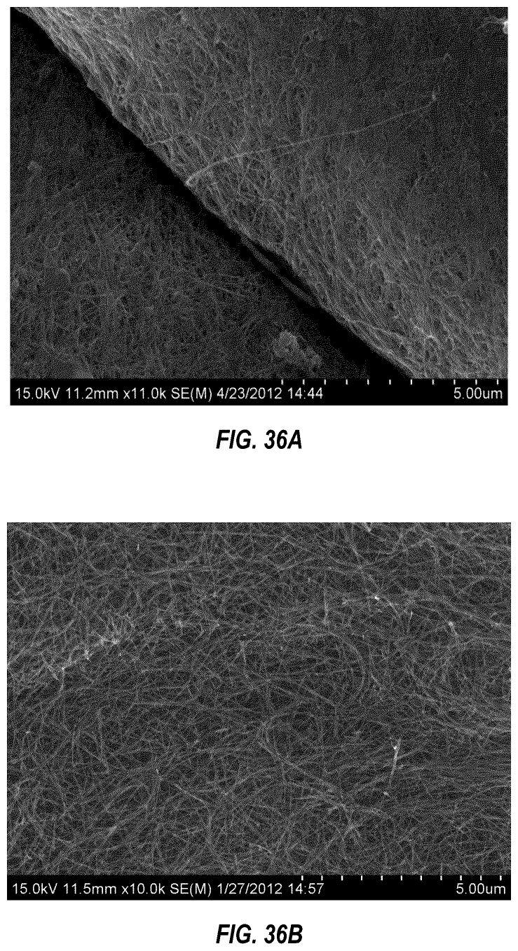

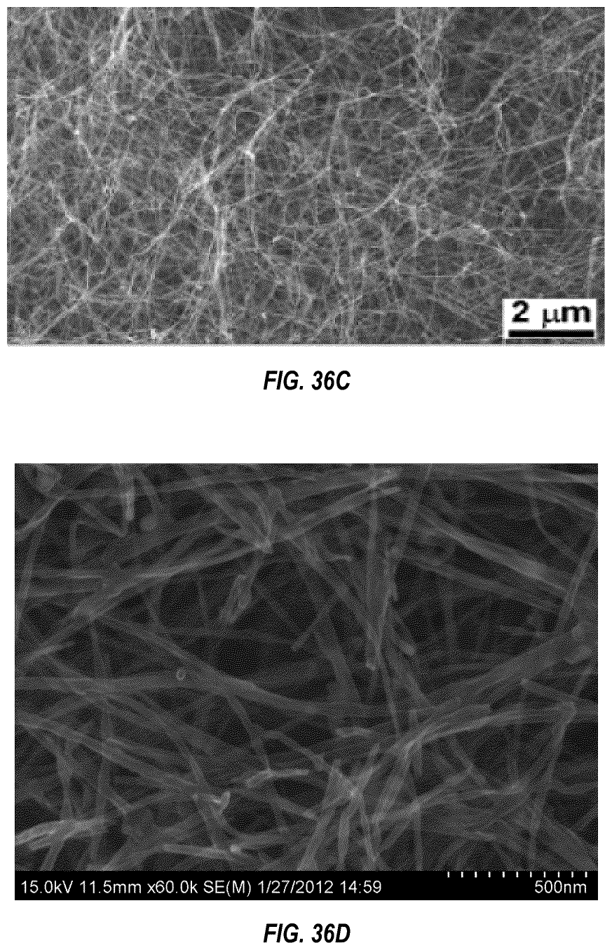

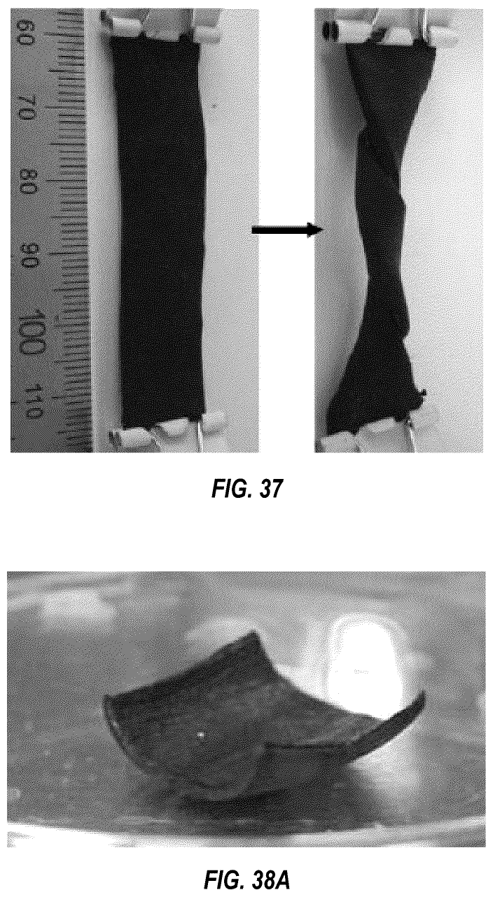

FIG. 35 shows the approximate thickness of a CNT-based Nano-Sponge formed by growing approximately 10 μm of the second VA-CNT-NF on top of the approximately 11 μm thick first VA-CNT-NF), for a total thickness of approximately 21 μm. FIGS. 36A-36D are SEM micrographs of the side of the Nano-Sponge at successively higher magnifications. The Nano-Sponge can be very flexible, as seen by the twisting shown on the right side of FIG. 37.

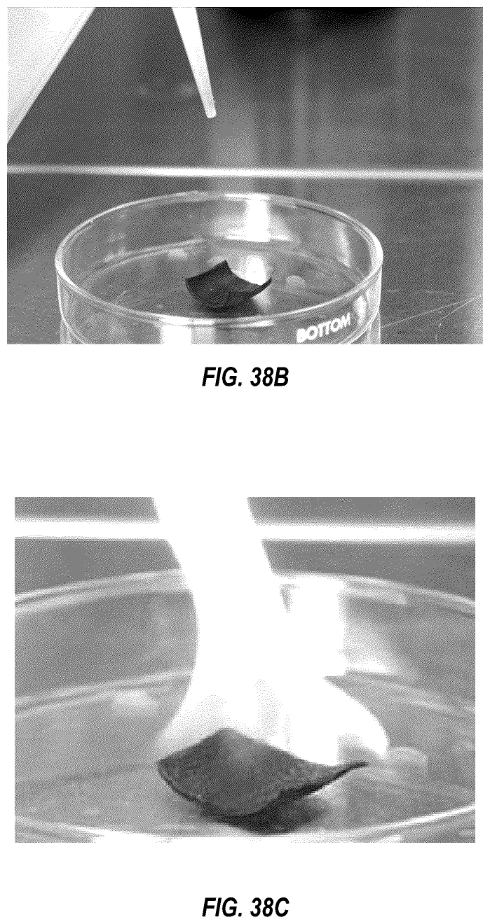

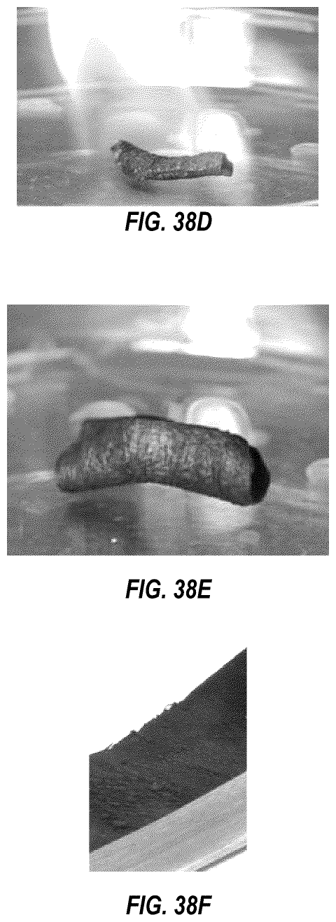

FIGS. 38A-38E show a flame test being performed on the Nano-Sponge. FIG. 38A shows the as-manufactured Nano-Sponge at the beginning of the flame test. FIG. 38B shows acetone being dropped on the Nano-Sponge and FIG. 38C shows the acetone being set on fire. FIG. 38D shows shriveling of the Nano-Sponge near the end of the flame test as trapped acetone is burned away. FIG. 38E shows the Nano-Sponge immediately after the flame test, when it can be handled without discomfort in terms of heat and temperature. FIG. 38F shows the Nano-Sponge of FIG. 38E opened and held under a Ruler to demonstrate that the Nano-Sponge held its original shape after the flame test. The dimensions are approximately 10 mm×10 mm×1 mm.

Note that in the specification and claims, “about” or “approximately” means within twenty percent (20%) of the numerical amount cited. As used herein, the singular forms “a,” “an,” and “the” include plural referents unless the context clearly dictates otherwise. Thus, for example, reference to “a functional group” refers to one or more functional groups, and reference to “the method” includes reference to equivalent steps and methods that would be understood and appreciated by those skilled in the art, and so forth.

Although the invention has been described in detail with particular reference to the disclosed embodiments, other embodiments can achieve the same results. Variations and modifications of the present invention will be obvious to those skilled in the art and it is intended to cover all such modifications and equivalents. The entire disclosures of all patents and publications cited above are hereby incorporated by reference.

What is claimed is:

1. A nanoforest-based reinforcement comprising:
a first layer comprising elongated nanostructures oriented substantially parallel to a surface of a substrate;
an intervening layer comprising a substantially uniform layer of catalyst; and
a second layer comprising a nanoforest comprising elongated nanostructures that are oriented substantially perpendicular to the surface of the substrate;
wherein the second layer has been grown directly on the first layer; and
wherein a uniform layer of catalyst is present between the first layer and the second layer.

2. The nanoforest-based reinforcement of claim 1 wherein the first layer comprises a collapsed nanoforest, the nanoforest originally comprising elongated nanostructures which were oriented substantially perpendicular to the surface of the substrate.

3. The nanoforest-based reinforcement of claim 1 wherein said second layer has a height between about 10 microns and about 20 microns.

4. The nanoforest-based reinforcement of claim 1 wherein said first layer has a height between about 5 microns and about 10 microns.

5. The nanoforest-based reinforcement of claim 1 having a total height of less than about 50 microns.

6. The nanoforest-based reinforcement of claim 1 wherein the elongated nanostructures comprise carbon, gold, BN, Si, CuO, or ZnO.

7. A composite part comprising a plurality of layers each comprising the nanoforest-based reinforcement of claim 1 interleaved with a plurality of fiber reinforcement layers.

8. The composite part of claim 7 wherein each of the plurality of layers of the nanoforest-based reinforcement fills between about 40% and about 80% of a distance between consecutive fiber reinforcement layers.

9. The composite part of claim 8 wherein each of the plurality of layers of the nanoforest-based reinforcement has a height of 20-40 micrometers to fill a gap of 50 micrometers between consecutive fiber reinforcement layers.

10. The composite part of claim 7 wherein the nanoforest-based reinforcement was grown directly on the fiber reinforcement layers.

11. The composite part of claim 7 comprising a matrix comprising a material selected from the group consisting of cured epoxy, cured thermosetting polymer resin, cured thermoplastic polymer resin, cured polyimide resin, cured bismaleimide resin, and ceramized preceramic polymer.

12. The composite part of claim 7 wherein said fiber reinforcement layers comprise carbon, glass, para-aramid synthetic fiber, polyethylene fiber, silicon carbide, silicon nitride, alumina, other ceramic fibers, or combinations thereof.

13. The composite part of claim 7 wherein each fiber reinforcement layer comprises a fabric.

14. The composite part of claim 13 wherein the fabric comprises a metal fabric.

15. The composite part of claim 7 wherein each fiber reinforcement layer comprises a unidirectional prepreg and/or a fabric prepreg.

16. The composite part of claim 7 comprising a sandwich structure comprising face sheets and one or more core/honeycomb portions, wherein the nanoforest-based reinforcement is located at interfaces between the face sheets and the core/honeycomb portions.

17. The composite part of claim 7 comprising a flat, curved, contoured, or multi-curvature geometry.
